(19) United States
(12) Patent Application Publication
(10) Pub. No.: US 2005/0159131 A1
(43) Pub. Date: Jul. 21, 2005

(54) Communicator and vehicle controller

(75) Inventors: Toshimasa Shibagaki, Niwa-gun (JP); Shigenori Nitta, Niwa-gun (JP); Masaki Kawashima, Niwa-gun (JP); Noriyasu Onishi, Toyota-shi (JP)

Correspondence Address: SYNNESTVEDT & LECHNER, LLP, 2600 ARAMARK TOWER, 1101 MARKET STREET, PHILADELPHIA, PA, 191072950, US

(73) Assignee: Kabushiki Kaisha Tokai Rika Denki Seisakusho, Niwa-gun (JP)

(21) Appl. No.: 11/038,301

(22) Filed: Jan. 19, 2005

(30) Foreign Application Priority Data
Jan. 21, 2004 (JP) 2004-013626

(51) Int. Cl. H04B 1/18

(52) U.S. Cl. 455/345; 455/352; 455/269; 455/129

(57) ABSTRACT

An inexpensive communicator that forms an optimal communication electric field. A vehicle interior transmitter circuit includes a main transmitter circuit having a ferrite antenna for generating a main electric field. A closed loop antenna includes a basal end coil, inductively coupled to the main antenna, and a distal end coil, for generating an auxiliary electric field based on the inductive coupling.

### BACKGROUND OF THE INVENTION

The present invention relates to a communicator and a vehicle controller incorporating the communicator. More particularly, the present invention relates to a communicator including an antenna and a vehicle controller including such a communicator.

A smart key system provided with a smart ignition function has been proposed in the prior art (e.g., Japanese Laid-Open Patent Publication No. 2000-255381). In such a smart key system, when a portable device corresponding to a vehicle is carried into the vehicle, communication automatically takes place between the portable device and an engine start controller, which is installed in the vehicle. When confirming through the communication that the portable device corresponds to the vehicle, the engine start controller enables the starting of the engine.

More specifically, referring to FIG. 1, an engine start controller includes a transmitter 62, which is installed in a vehicle 61 to transmit a request signal (i.e., generate an electromagnetic field). When the portable device 63 enters a request signal receivable region 64, the portable device 63 outputs a reply signal in response to the request signal. The engine start controller further includes a receiver 65, which checks whether the portable device corresponds to the vehicle based on the reply signal. The engine start controller enables the starting of the engine when the portable device corresponds to the vehicle.

In recent years, a plurality of transmitters are installed in the vehicle so that the portable device can receive the request signal in an optimal manner.

In a luxury car, costs do not necessarily have to be reduced. Thus, a plurality of transmitters may be installed in the vehicle to perform communication in an optimal manner. Conversely, in an economy car, it is difficult to install more than one transmitter in the vehicle since costs have to be reduced. Thus, there is a demand for technology that enables a plurality of transmitters to be used at the same cost as when using only one transmitter while performing communication in a optimal manner.

### SUMMARY OF THE INVENTION

It is an object of the present invention to provide an inexpensive communicator and vehicle controller that forms an optimal electric field for use in communication.

One aspect of the present invention is a communicator including a main electric field generation unit including a main antenna for generating a main electric field. A closed loop antenna includes a basal end coil, inductively coupled to the main antenna, and a distal end coil, for generating an auxiliary electric field based on the inductive coupling.

Another aspect of the present invention is a controller for use in a vehicle with a portable device. The vehicle includes a controlled subject. The portable device transmits a reply signal in response to a request signal. The controller includes a communication unit for communicating with the portable device. A control unit, connected to the controlled subject and the communication unit, controls the controlled subject based on communication between the portable device and the communication unit. The communication unit includes a transmitter unit with a main electric field generation unit having a main antenna for generating a main electric field, and a closed loop antenna with a basal end coil, inductively coupled to the main antenna, and a distal end coil, for generating an auxiliary electric field based on the inductive coupling. The transmitter unit transmits the request signal to the portable device using the main electric field and the auxiliary electric field. A receiver unit receives the reply signal from the portable device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of a vehicle in the prior art;

FIG. 2 is a block diagram showing a smart key system according to a preferred embodiment of the present invention;

FIG. 3 is a schematic diagram showing a vehicle of the preferred embodiment;

FIG. 4 is a schematic, partial cross-sectional view showing a main transmitter circuit, a case, and basal end coils;

FIG. 5 is a schematic perspective view showing a closed loop antenna; and

FIG. 6 is a circuit diagram showing a modification of the closed loop antenna.

### DETAILED DESCRIPTION OF THE PREFERRED EMBODIMENTS

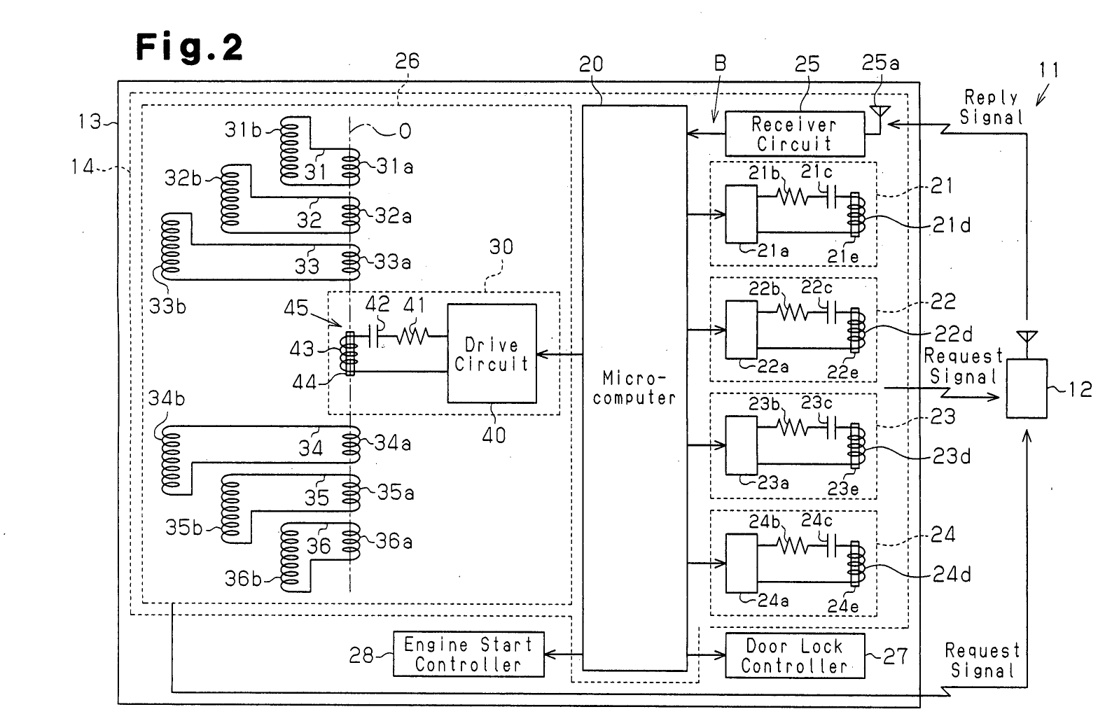

A vehicle interior transmitter circuit 26 and a vehicle controller 14 according to a preferred embodiment of the present invention will now be discussed with reference to FIGS. 2 to 5.

Referring to FIG. 2, a smart key system 11 for use in an automobile includes a portable device 12, which is carried by a user, and a vehicle controller 14, which is installed in a vehicle 13 and which communicates with the portable device 12. The vehicle controller 14 includes a microcomputer 20, four vehicle exterior transmitter circuits 21, 22, 23, and 24, a receiver circuit 25 including an antenna 25a, and a vehicle interior transmitter circuit 26. The microcomputer 20 functions as a control unit, the receiver circuit 25 functions as a receiver unit, and the vehicle interior transmitter circuit 26 functions as a communicator and a transmitter unit. The vehicle exterior transmitter circuits 21, 22, 23, and 24, the receiver circuit 25, and the vehicle interior transmitter circuit 26 form a communication device B, which functions as a communication unit. The microcomputer 20 is connected to a door lock controller 27, which functions as a controlled subject, and an engine start controller 28, which also functions as a controlled subject.

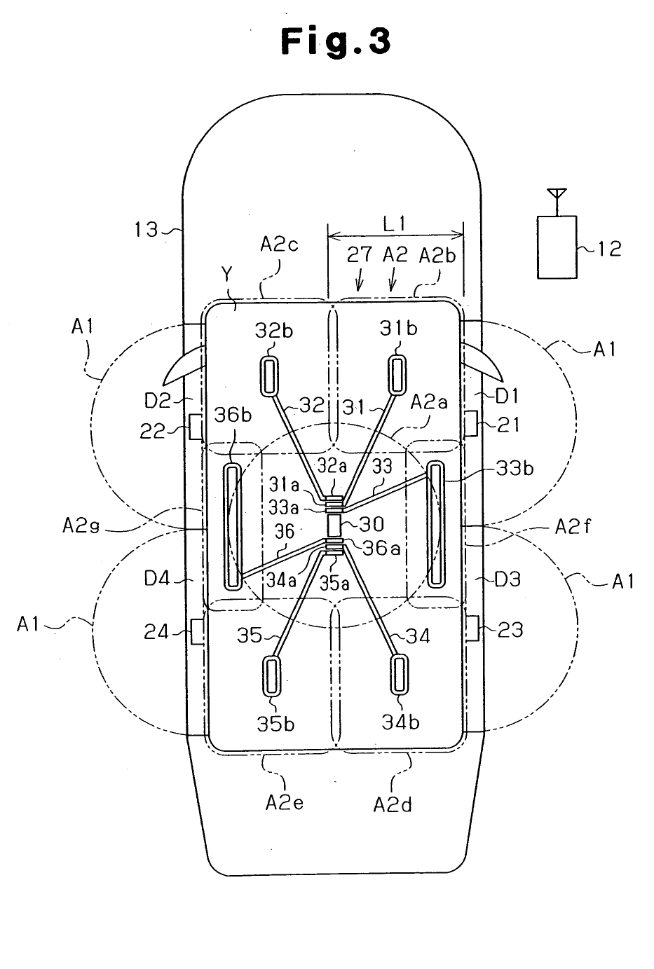

Referring to FIG. 3, in the vehicle 13, the vehicle exterior transmitter circuits 21 to 24 are respectively installed in the right front door D1, left front door D2, right rear door D3, and left rear door D4.

Referring to FIG. 2, the vehicle exterior transmitter circuit 21 is a so-called series-connected resonance circuit. The vehicle exterior transmitter circuit 21 includes a drive circuit 21a connected to the microcomputer 20, a resistor 21b, a capacitor 21c, an antenna coil 21d, and a ferrite coil 21e arranged in the antenna coil 21d. The resistor 21b, the capacitor 21c, and the antenna coil 21d are connected in series to the drive circuit 21a. In the same manner as the vehicle exterior transmitter circuit 21, the vehicle exterior transmitter circuits 22 to 24 include drive circuits 22a to 24a, resistors 22b to 24b, capacitors 22c to 24c, antenna coils 22d to 24d, and ferrite cores 22e to 24e, respectively. These elements are connected in the same manner as in the vehicle exterior transmitter circuit 21.

The microcomputer 20 generates a request signal and provides the request signal to the drive circuits 21a to 24a. When receiving the request signal from the microcomputer 20, the drive circuits 21a to 24a modulate the request signal and transmit the modulated request signal from the associated antenna coils 21d to 24d. The request signal transmitted from each of the antenna coils 21d to 24d forms an electric field. More specifically, the antenna coils 21d to 24d each transmit the request signal out of the vehicle 13 from the associated doors D1 to D4. When located in vehicle exterior regions A1, which are shown in FIG. 3, the portable device 12 receives the request signal from the vehicle exterior transmitter circuits 21 to 24.

Referring to FIG. 2, the portable device 12 transmits (returns) a reply signal, which includes an ID code, in response to the request signal from the vehicle exterior transmitter circuits 21 to 24.

The receiver circuit 25, which is connected to the microcomputer 20, receives the reply signal transmitted from the portable device 12 located in one of the vehicle exterior regions A1 via the antenna 25a. When the receiver circuit 25 receives the reply signal, the receiver circuit 25 demodulates the reply signal and provides the demodulated reply signal to the microcomputer 20.

When receiving the reply signal, the microcomputer 20 compares the ID code included in the reply signal with an ID code stored in the microcomputer 20 to perform vehicle exterior authentication. When the two ID codes are identical, the microcomputer 20 controls the door lock controller 27 to unlock the doors D1 to D4 (refer to FIG. 3).

The vehicle interior transmitter circuit 26, which is connected to the microcomputer 20, is arranged in the floor of the vehicle 13. The vehicle interior transmitter circuit 26 is capable of transmitting a request signal throughout the entire vehicle 13.

When the portable device 12 is located in the vehicle 13 (more specifically, located in vehicle interior region A2), the portable device 12 receives the request signal from the vehicle interior transmitter circuit 26. When receiving the request signal from the vehicle interior transmitter circuit 26, the portable device 12 transmits (returns) a reply signal, which includes an ID code.

The receiver circuit 25 receives the reply signal transmitted form the portable device 12, which is located in the vehicle interior region A2. When receiving the reply signal, the receiver circuit 25 demodulates the reply signal and provides the demodulated reply signal to the microcomputer 20.

When receiving the reply signal, the microcomputer 20 compares the ID included in the reply signal with an ID code stored in the microcomputer 20 to perform vehicle interior authentication. When the two ID codes are identical, the microcomputer 20 controls the engine start controller 28 and enables the starting of the engine. When the starting of the engine is enabled, an engine start switch (not shown), which is arranged in the vehicle 13, is operated to start the engine.

The smart key system 11 improves convenience when the user enters the vehicle 13.

The configuration of the vehicle interior transmitter circuit 26 will now be described in detail.

Referring to FIG. 2, the vehicle interior transmitter circuit 26 includes a main transmitter circuit 30, which functions as a main electric field generation unit, and six closed loop antennas 31, 32, 33, 34, 35, and 36.

The main transmitter circuit 30 is arranged in the center of a rectangular floor surface Y (refer to FIG. 3). The main transmitter circuit 30 is a so-called series-connected resonance circuit. The main transmitter circuit 30 includes a drive circuit 40 connected to the microcomputer 20, a resistor 41, a capacitor 42, an antenna coil 43, and a bar-shaped ferrite core 44 arranged in the antenna coil 43. The resistor 41, the capacitor 42, and the antenna coil 43 are connected in series to the drive circuit 40. The antenna coil 43 and the ferrite core 44 form a ferrite antenna 45. The ferrite antenna 45 functions as a main antenna and as a bar antenna.

The main transmitter circuit 30 receives the request signal from the microcomputer 20, modulates the request signal, and transmits the modulated request signal from the ferrite antenna 45. The request signal transmitted from the ferrite antenna 45 forms a main electric field.

Referring to FIG. 3, when the portable device 12 is located in a main electric field region A2a, the portable device 12 receives the request signal transmitted from the ferrite antenna 45. More specifically, the main electric field region A2a extends around the center of the floor surface Y in a circular manner but does not reach the doors D1 to D4.

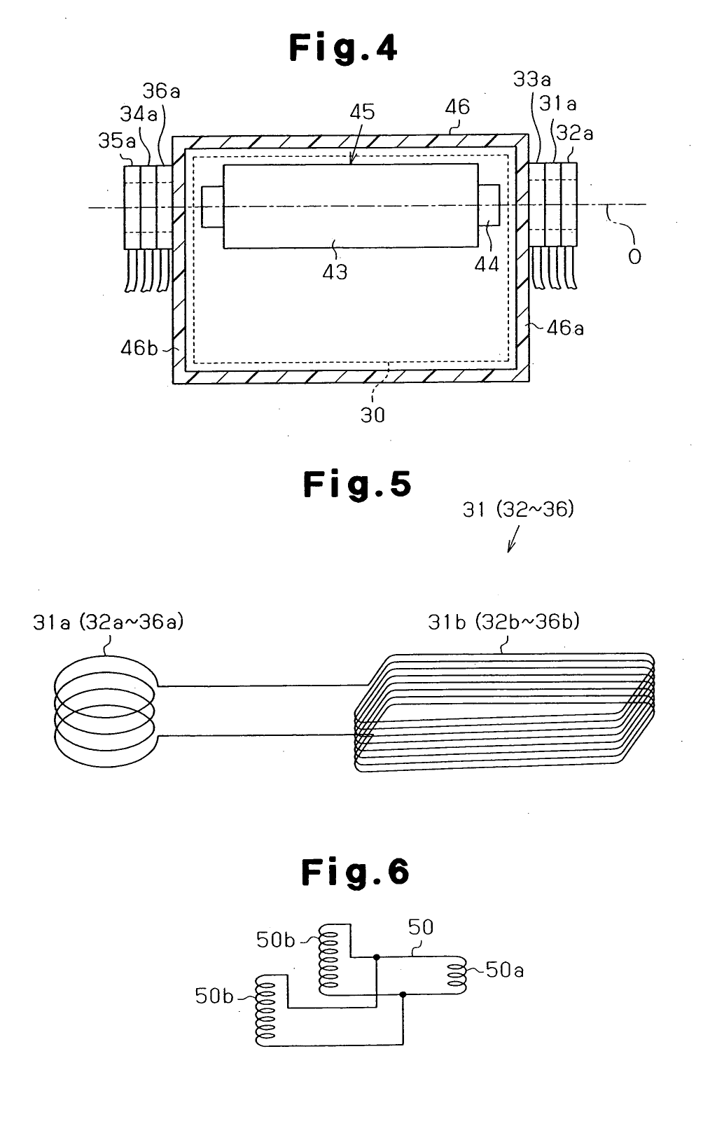

As shown in FIG. 4, the main transmitter circuit 30 is accommodated in a box-shaped case 46, which has a wall with opposing sides 46a and 46b and which is made of synthetic resin. The ends of the ferrite core 44 are arranged near the inner surfaces of the two wall sides 46a and 46b.

As shown in FIGS. 3 and 5, the closed loop antennas 31 to 36 are electric wires forming closed loops and have basal and distal end portions that are spirally wound to form basal end coils 31a to 36a and distal end coils 31b to 36b, respectively. In this preferred embodiment, the basal end coils 31a to 36a are formed by winding the electric wire four times into circular rings, and the distal end coils 31b to 36b are formed by winding the electric wires eight times into rectangular rings.

Referring to FIG. 4, the basal end coils 31a to 33a are fixed to the outer surface of the wall side 46a, and the basal end coils 34a to 36a are fixed to the outer surface of the wall side 46b. That is, the basal end coils 31a to 36a are arranged near the ferrite core 44 with the wall sides 46a and 46b arranged in between. Each of the basal end coils 31a to 36a has a center lying along the axis O of the ferrite core 44.

Referring to FIG. 2, when the ferrite antenna 45 transmits the request signal, the basal end coils 31a to 36a of the closed loop antennas 31 to 36 are inductively coupled to the antenna coil 43. The inductive coupling causes current to flow through the closed loop antennas 31 to 36. As a result, the request signal is transmitted to the surroundings of the distal end coils 31b to 36b. The request signal transmitted from the distal end coils 31b to 36b forms auxiliary electric fields.

Referring to FIG. 3, the distal end coils 31b, 32b, 34b, 35b are respectively arranged in the floor in correspondence with the right front seat, the left front seat, the right rear seat, and the left rear seat. The portable device 12 receives the request signal when located in the auxiliary electric field regions A2b, A2c, A2d, and A2e from the associated distal end coils 31b, 32b, 34b, and 35b.

The auxiliary electric field regions A2b, A2c, A2d, and A2e are rectangular in correspondence with the shape and size of the distal end coils 31b, 32b, 34b, and 35b. The auxiliary electric field regions A2b, A2c, A2d, and A2e are smaller than the main electric field region A2a. The auxiliary electric field regions A2b, A2c, A2d, and A2e respectively extend around the right front seat, the left front seat, the right rear seat, and the left rear seat so as to substantially cover the four corners of the floor surface Y in the vehicle 13.

The distal end coils 33b and 36b are arranged in the floor at the sides of the vehicle. That is, the distal end coil 33b is arranged near the doors D1 and D3, and the distal end coil 36b is arranged near the doors D2 and D4. The distal end coils 33b and 36b are formed as rectangular rings longer in the longitudinal direction of the vehicle 13 than the distal end coils 31b, 32b, 34b, and 35b. When located in auxiliary electric field regions A2f and A2g, the portable device 12 receives the request signal from the associated distal end coils 33b and 36b.

The auxiliary electric field regions A2f and A2g are rectangular in correspondence with the shape and size of the distal end coils 33b and 36b. The auxiliary electric field regions A2f and A2g are smaller than the main electric field region A2a.

The main electric field region A2a is partially overlapped with the auxiliary electric field regions A2b to A2g. Further, adjacent ones of the auxiliary electric field regions A2b to A2g are partially overlapped with each other. Accordingly, the main electric field region A2a and the auxiliary electric field regions A2b to A2g form the rectangular vehicle interior region A2 (cooperation electric field region). The vehicle interior region A2 covers substantially the entire floor surface Y.

The vehicle controller 14 of this preferred embodiment has the advantages described below.

(1) The vehicle interior transmitter circuit 26 includes the ferrite antenna 45 and the closed loop antennas 31 to 36, each having a structure that is simpler than the structure of the ferrite antenna 45. The vehicle interior transmitter circuit 26 includes only one ferrite antenna 45. However, the vehicle interior transmitter circuit 26 generates a plurality of electric fields (i.e., the electric fields generated in the main electric field region A2a and the auxiliary electric field regions A2b to A2g). In other words, in the preferred embodiment, the addition of the closed loop antennas 31 to 36, which are simpler than the ferrite antenna 45, enables the generation of a large electric field. The manufacturing cost of the vehicle interior transmitter circuit 26 is about the same as that of the transmitter 62 in the prior art. That is, the vehicle interior transmitter circuit 26 is inexpensive and forms the optimal electric field in the vehicle 13.

(2) The center of each of the basal end coils 31a to 36a lies along the axis 0 of the ferrite core 44. Further, the basal end coils 31a to 36a are located near the ferrite core 44. The strength of the request signal transmitted from the ferrite antenna 45 is significantly high at positions near the ferrite core 44 and lying along the axis O of the ferrite core 44. Accordingly, the optimal inductive coupling of the basal end coils 31a to 36a and the antenna coil 43 optimally forms auxiliary electric fields.

(3) The auxiliary electric fields A2b to A2g generated by the distal end coils 31b to 36b are shaped to be rectangular like the rectangular distal end coils 31b to 36b. In a typical ferrite antenna, the directivity is adjusted to change the electric field region. In this procedure, a rectangular electric field cannot be generated. However, with the closed loop antennas 31 to 36, the distal end coils 31b to 36b are shaped to generate electric fields with the desirable forms. This is effective when transmitting the request signal throughout the entire vehicle.

(4) The circular main electric field region A2a cooperates with the rectangular auxiliary electric field regions A2b to A2g to form the vehicle interior region A2 that covers the entire rectangular floor surface Y. That is, the vehicle interior region A2 covers the entire floor surface Y without extending out of the floor surface Y and without forming any gaps.

In the preferred embodiment, the engine is started when the engine start switch is operated after checking that the two ID codes are identical through vehicle interior authentication. If the vehicle interior region A2 were to extend out of the doors D1 to D4, a third person may operate the engine start switch and start the engine even when the user carrying the portable device 12 is outside the doors D1 to D4. However, in the preferred embodiment, the vehicle interior region A2 does not extend out of the doors D1 to D4. This prevents unintentional starting of the engine, for example, by a third person.

There is a type of vehicle that locks the doors if a lock switch located outside the doors is operated when the vehicle interior authentication is not being performed. When such lock control is performed with the vehicle 13, this configuration prevents the user from being locked out of the vehicle 13 when forgetting the portable device 12 in the vehicle 13. Further, if the vehicle interior region A2 were to extend out of the vehicle 13, vehicle interior authentication would be performed when the portable device 12 is located outside the doors D1 to D4. In such a case, the doors D1 to D4 cannot be locked even if the user operates a lock switch. However, such a problem does not occur in the preferred embodiment since the vehicle interior region A2 does not extend out of the doors D1 to D4.

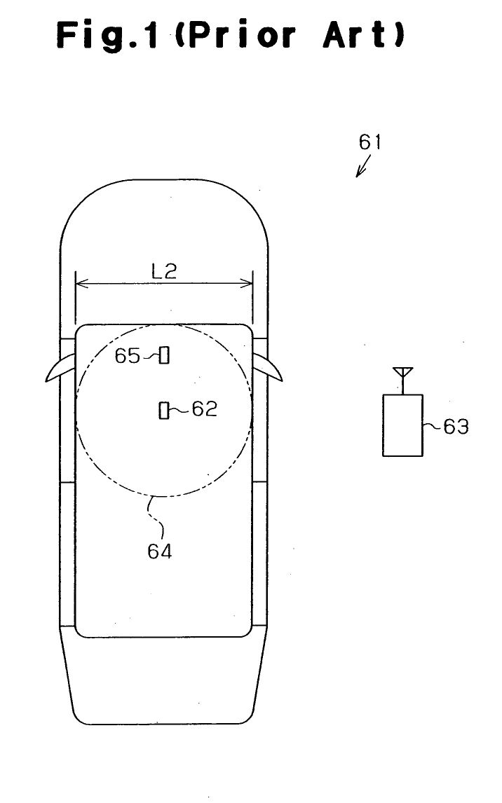

(5) Differences in the size of the vehicle interior region A2 in the preferred embodiment are less than differences in the size of the region 64 in the prior art shown in FIG. 1. The length of the auxiliary electric field region A2b, which forms the vehicle interior area A2 in the preferred embodiment, in the lateral direction of the vehicle 13 (hereafter referred to as length L1) is approximately half the width of the vehicle 13. The length of the region 64 in the prior art (hereafter referred to as length L2) is approximately the same as the width of the vehicle. That is, the length L1 of the auxiliary electric field region A2b in the preferred embodiment is approximately one half the length L2 of the region 64 in the prior art.

Under the assumption that the length L1 is 80 cm, the length L2 is 160 cm, and the product difference (tolerance) of the main transmitter circuit 30 in the preferred embodiment and the transmitter 62 in the prior art is ±5%, the auxiliary electric field region A2b and the region 64 vary in the range of ±5%. Thus, the length L1 varies in the range of ±4 cm, and the length L2 varies in the range of ±8 cm.

In this manner, a smaller electric field region reduces differences in the area of the electric field region that would be caused by product differences of the main transmitter circuit 30. Accordingly, in the vehicle interior region A2 of the preferred embodiment, area differences are reduced in comparison to the region 64 of the prior art. This is effective for transmitting the request signal throughout the entire vehicle but not outside the vehicle.

(6) The main electric field region A2a, which forms the inner part of the vehicle interior region A2, is larger than the auxiliary field areas A2b to A2g, which form the peripheral part of the vehicle interior region A2. The large main electric field region A2a, which forms the inner part of the vehicle interior region A2, reduces the number of electric field regions forming the vehicle interior region A2. Further, the small auxiliary electric field regions A2b to A2g reduces differences in the area of the vehicle interior region A2, as described in advantage (5).

(7) The auxiliary field regions A2b to A2g are formed with the desired sizes by adjusting the level of the current flowing through the closed loop antennas 31 to 36, the size (diameter) of the basal end coils 31a to 36a and the distal end coils 31b to 36b, and the winding amount of the basal end coils 31a to 36a and the distal end coils 31b to 36b. Further, the auxiliary field regions A2b to A2g are formed with the desired shapes by appropriately setting the shapes of the distal end coils 31b to 36b. Accordingly, the size and shape of the vehicle interior region A2 may easily be designed even if the size and shape of the floor surface Y changes in accordance with the vehicle model. This increases the freedom of design.

It should be apparent to those skilled in the art that the present invention may be embodied in many other specific forms without departing from the spirit or scope of the invention. Particularly, it should be understood that the present invention may be embodied in the following forms.

In the preferred embodiment, the main electric field region A2a, which forms the inner part of the vehicle interior region A2, is larger than the auxiliary electric field regions A2b to A2g, which form the peripheral part of the vehicle interior region A2. Instead, the main electric field region A2a, which forms the inner part of the vehicle interior region A2, may be about the same or smaller than the auxiliary electric field regions A2b to A2g, which form the peripheral part of the vehicle interior region A2.

In the preferred embodiment, the distal end coils 31b to 36b of the closed loop antennas 31 to 36 are rectangular rings. The distal end coils 31b to 36b may be ellipsoidal rings or non-circular rings, such as triangular rings and trapezoidal rings. This would generate ellipsoidal or non-circular, such as triangular and trapezoidal, auxiliary electric field regions. As will be understood, the distal end coils 31b to 36b may be circular.

In the preferred embodiment, the basal end coils 31a to 36a are located near and coaxially with the ferrite core 44 so that optimal inductive coupling occurs with the antenna coil 43. Instead, the basal end coils 31a to 36a may be arranged at any position along the outer side of the antenna coil 43 as long as inductive coupling occurs with the antenna coil 43.

The ferrite core 44 may be lengthened and the basal end coils 31a to 36a may be wound around such a lengthened ferrite core 44.

In the preferred embodiment, the distal end coils 31b to 36b of the closed loop antennas 31 to 36 are arranged in the floor. Instead, the distal end coils 31b to 36b may be arranged in the ceiling, an attachment arranged in the ceiling, the glove compartment, the trunk, a luggage space, or the instrument panel.

The distal end coils 31b to 36b of the closed loop antennas 31 to 36 may be arranged at locations where coil noise occurs and optimal communication cannot be performed with the portable device 12. In this case, even at locations where strong noises occur, the portable device 12 may optimally receive the request signal.

The configuration of the main transmitter circuit 30 may be applied to at least one of the vehicle exterior transmitter circuits 21 to 24, while the configuration of the closed loop antennas 31 to 36 is applied to the remaining vehicle exterior transmitter circuits.

In the preferred embodiment, the closed loop antennas 31 to 36 each includes one of the basal end coils 31a to 36a and one of the distal end coils 31b to 36b. Instead, as shown in FIG. 6, a closed loop antenna 50 may include a single basal end coil 50a and a plurality of (e.g., two) distal end coils 50b.

In the preferred embodiment, the main transmitter circuit 30 includes the ferrite antenna 45. The main transmitter circuit 30 may use a known antenna in lieu of the ferrite antenna 45.

In the preferred embodiment, the vehicle interior transmitter circuit 26 is used as a transmitter. The ferrite antenna 45 and the closed loop antennas 31 to 36 forming the vehicle interior transmitter circuit 26 are used as a transmitter (component). Instead, the vehicle interior transmitter circuit 26 may be used as a receiver or a transceiver. That is, the ferrite antenna 45 and the closed loop antennas 31 to 36 may be used as a receiver (component) or a transceiver (component).

The present examples and embodiments are to be considered as illustrative and not restrictive, and the invention is not to be limited to the details given herein, but may be modified within the scope and equivalence of the appended claims.

1. A communicator comprising:
a main electric field generation unit including a main antenna for generating a main electric field; and
a closed loop antenna including a basal end coil, inductively coupled to the main antenna, and a distal end coil, for generating an auxiliary electric field based on the inductive coupling.

2. The communicator according to claim 1, wherein the main antenna includes a bar antenna having an axis, and the basal end coil is arranged along the axis of the bar antenna.

3. The communicator according to claim 1, wherein the closed loop antenna is one of a plurality of closed loop antennas, and the main antenna and the closed loop antennas are configured so that a plurality of auxiliary electric fields are formed around the main electric field, with each of the auxiliary electric fields being smaller than the main electric field.

4. The communicator according to claim 1, wherein the main antenna and the closed loop antenna are configured so that the main electric field and the auxiliary electric field form a rectangular electric field.

5. The communicator according to claim 1, further comprising:
a case for accommodating the main electric field generation unit and including a wall with a first side facing inwards relative to the case and a second side opposite to the first side, the main antenna including an end located near the first side of the wall, and the basal end coil being fixed to the second side of the wall.

6. The communicator according to claim 1, wherein the distal end coil is one of a plurality of distal end coils included in the closed loop antenna.

7. A controller for use in a vehicle with a portable device, the vehicle including a controlled subject, and the portable device transmitting a reply signal in response to a request signal, the controller comprising:
a communication unit for communicating with the portable device; and
a control unit, connected to the controlled subject and the communication unit, for controlling the controlled subject based on communication between the portable device and the communication unit, the communication unit including:
a transmitter unit with a main electric field generation unit having a main antenna for generating a main electric field, and a closed loop antenna with a basal end coil, inductively coupled to the main antenna, and a distal end coil, for generating an auxiliary electric field based on the inductive coupling, the transmitter unit transmitting the request signal to the portable device using the main electric field and the auxiliary electric field; and
a receiver unit for receiving the reply signal from the portable device.

8. The controller according to claim 7, wherein the closed loop antenna is one of a plurality of closed loop antennas, and the main antenna and the closed loop antennas are configured so that a plurality of auxiliary electric fields are formed around the main electric field to cover the entire vehicle, with each of the auxiliary electric fields being smaller than the main electric field.
